(19) United States
(12) Patent Application Publication
(10) Pub. No.: US 2014/0111801 A1
(43) Pub. Date: Apr. 24, 2014

(54) DEVICES, SYSTEMS AND METHODS FOR DETERMINING DRUG COMPOSITION AND VOLUME

(71) Applicant: Gal A. COHEN, San Francisco, CA (US)

(72) Inventor: Gal A. COHEN, San Francisco, CA (US)

(21) Appl. No.: 14/054,744

(22) Filed: Oct. 15, 2013

Related U.S. Application Data
(60) Provisional application No. 61/714,169, filed on Oct. 15, 2012.

(51) Int. Cl. G01N 21/65

(52) U.S. Cl. CPC G01N 21/65
USPC 356/301

(57) ABSTRACT

Apparatuses and methods for determining the composition of liquid, including a liquid drug (e.g., IV drug) and a liquid drug waste. The apparatuses described herein may determine the identity of one or more drugs in the liquid, the concentration of the drug, and the type of diluent using spectroscopy (such as optical and/or complex immittance spectrographic information). These apparatuses (e.g., devices, systems) and methods are particularly useful for describing the identity and, in some variations, concentration of one or more components of a medical liquid such as intravenous fluid. Also described are methods of recognizing spectroscopic information, e.g., profiles of optical and/or complex immittance spectrograph patterns to determine the composition of a liquid by pattern recognition.

### CROSS REFERENCE TO RELATED APPLICATIONS

This patent application claims priority to U.S. Provisional Patent Application No. 61/714,169, filed Oct. 15, 2012, and titled “DEVICES, SYSTEMS AND METHODS FOR MONITORING DRUG WASTE COMPOSITION AND VOLUME” which is herein incorporated by reference in its entirety.

This patent application may be related to U.S. patent application Ser. No. 12/920,203, filed Aug. 30, 2010, titled “INTRAVENOUS FLUID MONITORING,” Publication No. US-2011-0009817-A1; U.S. patent application Ser. No. 12/796,567, filed Jun. 8, 2010, titled “SYSTEMS AND METHODS FOR THE IDENTIFICATION OF COMPOUNDS IN MEDICAL FLUIDS USING ADMITTANCE SPECTROSCOPY,” Publication No. US-2010-0305499-A1; and U.S. patent application Ser. No. 13/229,597, filed Sep. 9, 2011, titled “SYSTEMS AND METHODS FOR INTRAVENOUS DRUG MANAGEMENT USING IMMITTANCE SPECTROSCOPY,” Publication No. US-2012-0065617-A1, each of which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The devices, systems and methods described may be used to determine the identity and concentration of one or more, or in some variations all, components in an aqueous solution using spectroscopy. In particular, described herein are devices, systems and methods for using spectroscopy (including optical and/or immittance spectroscopy) to determine the composition of intravenous drug solutions.

### BACKGROUND

Unfortunately, there is currently no commercially available device capable of reliably determining both the identity and concentration (and thus dosage) of a wide variety of unknown intravenous fluids in a waste material. In particular, there it would be beneficial to provide an apparatus capable of reliably determining the identity and/or concentration of an unknown drug solution, such as an intravenous drug solution. Such apparatuses could be used when forming, dispensing, delivering, and/or disposing of aqueous solutions including drugs.

For example, it would be helpful to provide a method of determining the identity and composition of IV drug waste. Hospitals and other institutions are increasingly required to document proper disposal of environmentally sensitive waste and monitor for diversion of scheduled drugs. Thus, it would be helpful to provide devices, systems and method for confirming the amount and type of drug waste, and providing an accurate record of drug waste collected and/or disposed of. It would also be beneficial to sort drug waste so that different drug waste could be disposed of appropriately according to the compounds in the waste fluid.

The drug enforcement agency (DEA) has jurisdiction over scheduled (controlled) drugs such as fentanyl, morphine, and other opioids and drugs with high addiction potential. In the hospital, a key focus is on prevention and detection of diversion of these controlled medications. Hospitals can be legally liable for impaired healthcare provider taking diverted medication, or stealing them for resale. Diversion prior to patient administration may also cause missed pain medication doses.

The environmental protection agency (EPA) has jurisdiction over waste that can produce environmental harm including pharmaceutical waste from hospitals and clinics. Liquid IV waste can include toxic drugs (like chemotherapeutics) and antibiotics that need to be kept out of the normal water treatment stream and/or require incineration disposal. EPA has increased enforcement and penalties for pharmaceutical waste. The EPA and state environmental agencies can levy corporate fines up to $37,500 per violation per day (where a violation may equal one item discarded into the wrong waste stream). Some hospitals have been fined hundreds of thousands of dollars.

In addition to drug waste, it would be extremely beneficial to provide methods and apparatuses for monitoring and/or determining drug identity/concentration for patient consumption. Mistakes in drug delivery result may result in patient harm, including death.

Thus, hospitals and pharmacies need easy to use and effective ways of identifying aqueous drug solutions. For example, it would be beneficial to provide methods and systems capable of identifying, delivering, detecting and/or disposing of drugs in compliance with regulatory agencies such as the DEA and EPA. Described herein are apparatuses (e.g., devices and systems) and methods to determine the identity, and in some variations concentration, of one or more components of a liquid waste such as an intravenous solution.

### SUMMARY

Described herein are systems, devices and methods for determining the components of a liquid fluid (e.g., liquid, diluent or solution) using spectroscopic analysis, which may include but is not limited to immittance spectroscopy. As used herein, the term spectroscopy may refer to optical spectroscopy, immittance spectroscopy (both impedance spectroscopy and admittance spectroscopy) or the like. Although the examples described herein include primarily electrical (e.g., immittance) spectroscopy, any of these methods may also be adapted to work with other spectrographic techniques, including optical spectroscopy. In general, the devices, systems and methods described herein may be useful for determining the identity, concentration, or identity and concentration of one or more (or all) components of a liquid (including a drug liquid or a liquid waste). The solution may be an aqueous solution (an aqueous fluid). For example, the solution may be a medical liquid such as an intravenous fluid, and epidural fluid, a parenteral fluid, or the like. Thus, the components of the liquid may be drugs. In general, the components of the liquid may be any compound, including (but not limited to): ions, molecules, macromolecules, proteins, etc.

The devices or systems described herein can identify (or in the case of drug waste, identify and dispose of waste) liquid including drugs. Drugs can consist of a single chemical species, or multiple chemicals, including mixtures, formulations, or admixtures. Drug may be dissolved in water, saline, or other solvent. Drug may be in a container (vial, syringe, or other container), or it could be or poured, injected, or otherwise introduced onto or into a sensor, which may be positioned in an opening or chamber in an apparatus, or into a consumable which is later disposed of.

As described in detail herein, in some variations, the liquid material examined using spectroscopy. For example, liquid may be examined to determine drug composition using optical spectroscopy, e.g., Raman, IR, UV, or other spectroscopic technology. If necessary, more than one spectroscopic method could be used. Immittance spectroscopy is one particular type of non-optical spectroscopy that may be used alone or in combination. For instance, immittance spectroscopy could be used in conjunction with Raman spectroscopy.

In operation, the devices and systems described herein may include verifying the identity of drugs which are controlled substances before they are delivered, prescribed and/or disposed of (as “waste” material). Another use case could be identifying drugs such as chemotherapeutics which could be toxic if accidentally ingested or if introduced into the waste stream.

Compositional analysis may purely indicate the presence or absence of the drug of interest, or it may include the quantitative concentration or total dose. It may also include identification of other components in the formulation or mixture. Waste composition can be compared to expected composition (i.e., comparing detected composition to expected composition as entered by barcode identification of the drug, manual entry, or other input method), or it could be identified without comparing against expected composition.

The system or devices described herein may report the identity of the drug, for instance through a user interface on a display screen, or through a visual or auditory output, or through a networked connection for instance to another computer, or through a printout or other means. More than one output method may be employed. In one variant, the liquid (including drug) is collected in the machine itself, or travels through a path through the machine, or through a tube or external path, into a collection chamber, receptacle, or other holding instrument or compartment.

In any of the systems described herein, the apparatus may be configured to analyze the fluid and output what the material is and/or act on the fluid based on the determined information (identity and/or concentration). For example, an apparatus as described herein may be configured to confirm a compounded aqueous solution (e.g., to confirm the identity and/or concentration of an entire aqueous solution, including any and/or all components in the solution). Similarly, an apparatus for confirming or checking an intravenous (IV) drug solution may be connected to an IV line and/or pump for deliver to a patient.

In drug waste systems, the drug waste may not collected in the apparatus, but the device or system is purely for identification of the composition of the drug waste. In another variant, the drug waste is introduced into a disposable cartridge, vial, bag, chamber, or other container. The identity of the drug waste is tested while it is in the container, and then the container is disposed of. While the system can be used to spot check IV samples from IVs returned to the pharmacy for disposal, the system may systematically catalog all waste, documenting the drug, concentration and volume, and automatically segregate waste into the appropriate disposal containers for incineration or inactivation.

Any of the apparatuses described herein may use spectroscopy to identify an aqueous solution. As described in more detail below, a spectroscopy system as described here may take a spectrographic “fingerprint” of an aqueous solution by reading signals at various frequencies of applied energy (including optical energy). For example an optical “fingerprint” taken at one or more optical settings may be used to identify a drug composition. In another example electrical immittance spectroscopy may be used, in which a plurality of complex impedance measurements taken at a plurality different frequencies of applied electrical energy are examined; a plurality of different sensors (e.g., optical sensors, electrode pairs, etc.) may be used. For each pair of electrodes having a slightly different configuration (e.g., shape, size, composition) the complex impedance measurements taken with that set of electrodes may provide another set of data forming the “fingerprint” (e.g., the initial dataset). Different electrodes exposed to the liquid may have different surface interactions between the liquid and the electrodes. Electrode surfaces may be coated, doped, or treated to create different surface interactions.

For example, described herein are systems for collecting and identifying drug waste in a liquid. These systems may include: a waste input port to receive liquid drug waste; a sample chamber coupled to the waste input port, wherein the sample chamber comprises a an optically permeable region configured for spectroscopic measurement; a spectroscopic source and spectroscopic detector configured to measure spectroscopic signatures of liquid drug waste within the sample chamber at a plurality of frequencies; a processor configured to receive spectroscopic information at a plurality of frequencies, and to determine the identity and amount of drug in the liquid drug waste; and a collection chamber to collect liquid drug waste.

The spectroscopic source and spectroscopic detector may be configured to measure Raman signatures, IR signatures, and/or UV signatures. The system may further comprise a plurality of collection chambers. In some variations, the system may include a plurality of electrode pairs configured for immittance spectroscopy. The sample chamber may be a flow-through chamber configured to pass liquid drug waste therethrough, and further wherein the sample chamber is part of a replaceable cartridge. The system may also include a flow sensor to determine the flow rate of liquid drug waste entering the input port. The processor may be configured to log and/or report the identity and amount of drug in a received liquid drug waste. The system may also include an output to report the identity and amount of drug received. The processor is configured to direct the collection of liquid drug waste to one of a plurality of collection chambers based on the identity of the drug in a received liquid drug waste.

The system may also include a rinse module connected to a source of rinsate to rinse the sample chamber after delivery of a liquid drug waste.

The processor may be configured to compare determine the identity and amount of drug in the liquid drug waste received by comparing the spectroscopic signature to a library of spectroscopic signatures of known drugs.

Also described are systems for collecting and identifying drug waste in a liquid, the system comprising: a waste input port to receive liquid drug waste; a sample chamber coupled to the waste input port, wherein the sample chamber comprises an optically permeable region configured for spectroscopic measurement; a flow sensor configured to determine the flow of liquid into the system; a spectroscopic source and spectroscopic detector configured to provide optical energy to liquid drug waste within the sample chamber at a plurality of frequencies and to detect optical spectroscopic information from the liquid drug waste; a processor configured to receive optical spectroscopic information at a plurality of frequencies from the sample chamber, and to determine the identity and amount of drug in the liquid drug waste from the spectroscopic information and the flow sensor; and a collection chamber to collect liquid drug waste.

Also described are systems for collecting and identifying drug waste in a liquid, the system comprising: a waste input port to receive liquid drug waste; a sample chamber coupled to the waste input port, wherein the sample chamber is configured for spectroscopic measurement of liquid drug waste within the chamber, the sample chamber further comprising a plurality of electrode pairs configured to contact received liquid drug waste; a spectroscopic light source and spectroscopic detector configured to provide optical energy to liquid drug waste within the sample chamber to detect optical spectroscopic information from the liquid drug waste; a signal generator configured to provide electrical energy to liquid drug waste within the sample chamber at a plurality of frequencies; a processor configured to receive (optical) spectroscopic information and complex immittance information for a plurality of frequencies from the plurality of electrode pairs, and to determine the identity and amount of drug in a received liquid drug waste from the optical spectroscopic information and complex immittance information; and a collection chamber to collect liquid drug waste.

Also described are methods of collecting and identifying drug waste in a liquid, the method comprising: receiving a liquid drug waste; determining spectroscopic information from the liquid drug waste for a plurality of frequencies; determining the identity and amount of drug in the liquid drug waste by comparing the spectroscopic information to a library of known spectroscopic profiles; and collecting the liquid drug waste in a collection chamber. The method may further include recording the amount of drug in the liquid waste received. Receiving the liquid drug waste may comprise pumping the liquid drug waste into a waste input port of a system for collecting and identifying drug waste in a liquid.

The method may also comprise determining complex immittance information by applying electrical energy at a plurality of frequencies across the plurality of electrode pairs in contact with the liquid drug waste. Determining the identity and amount of drug may comprise using the complex immittance information to determine the identity and amount of drug in the liquid drug waste. In some variations, determining the identity and amount of drug comprises comparing the spectroscopic information with a library of spectroscopic information of known drugs to determine the identity and amount of drug in the liquid drug waste.

Collecting the liquid drug waste may comprise collecting liquid drug waste containing different drugs into different collection chambers.

In some variations the sensors described herein include a capillary port configured to wick sample liquid onto all of the sensors (e.g., electrodes in some variations and/or optical sensors). In some variations the sensor includes a retractable needle configured to load sample liquid onto all of the sensor(s).

The system may also include a plurality of collection chambers. In some variations, the system includes a replaceable cartridge holding the plurality chambers. The sample chamber may be a flow-through chamber configured to pass liquid drug waste therethrough, or a static sample chamber. The sample chamber and may form part of a replaceable cartridge.

The system may also include a flow sensor to determine the flow rate of liquid drug waste entering the input port. The processor may be configured to log and/or report the identity and amount of drug in a received liquid drug waste.

In some variations, the system includes an output to report the identity and amount of drug received.

In variations in which the solution is collected (e.g., waste collection systems), the processor may be configured to direct the collection of liquid (e.g., drug waste) to one of a plurality of collection chambers based on the identity of the drug in a received liquid.

Any of the systems described herein may also include a rinse module connected to a source of rinsate to rinse the sample chamber after delivery of a liquid (e.g., liquid drug waste).

The processor may be configured to determine the identity and amount of drug in the liquid received by comparing the spectrographic signal to a library of spectrographic signals of known drug solutions.

A method of collecting and identifying drug solutions may also include recording the amount of drug in the liquid received. In some variations, receiving a liquid drug waste comprises pumping the liquid drug waste into a waste input port of a system for collecting and identifying drug waste in a liquid. The step of collecting the liquid drug waste may comprise collecting liquid drug waste containing different drugs into different collection chambers.

Also described herein are methods of determining the identity of a drug or drug formulation by recognizing a pattern of spectrographic information from a library of known spectrographic information, the methods comprising: receiving an initial dataset comprising spectrographic information for an unknown liquid sample, the spectrographic information taken from a plurality of different frequencies; using a processor to apply one or more pattern recognition techniques to compare the initial dataset to an identification space database comprising a plurality of identification datasets wherein the identification datasets comprise data corresponding to known drug compositions to determine if the initial dataset matches an identification dataset from the identification space database within a threshold range; and reporting that the initial dataset does or does not match an identification dataset, and if the initial dataset does match an identification dataset within the threshold range, reporting which drug or drugs correspond to the identification dataset matched.

The step of using the processor to apply one or more pattern recognition techniques may comprise using a Neural Network, for example, a Probabilistic Neural Network. In some variations, using the processor to apply one or more pattern recognition techniques comprises reducing the dimension of the initial dataset and performing a regression analysis.

The step of receiving the initial dataset may comprise receiving an initial dataset having greater than 30 dimensions (or in some variations greater than 10 dimensions, greater than 20 dimensions, greater than 50 dimensions, etc.).

The method of determining the identity of a drug or drug formulation by recognizing a pattern of spectrographic information may also include setting the threshold range.

The step of using a processor to apply one or more pattern recognition techniques may comprise applying two pattern recognition techniques. For example, the method may include using the processor to apply one or more pattern recognition techniques comprises initially applying a PCA method to reduce the dimension of the data and then applying another pattern recognition technique to determine if the initial dataset matches an identification dataset. The step of using the processor to apply one or more pattern recognition techniques may comprise initially applying a PCA method to reduce the dimension of the dataset and then using a neural network to determine if the initial dataset matches an identification dataset. In some variations using the processor to apply one or more pattern recognition techniques comprises applying a linear technique selected from the group consisting of: principal component analysis, factor analysis, projection pursuit, independent component analysis, multi-objective functions, one-unit objective functions, adaptive methods, batch-mode algorithms, and random projections methods. Using the processor to apply one or more pattern recognition techniques may comprise applying a non-linear technique selected from the group consisting of: non-linear principle component analysis, non-linear independent component analysis, principle curves, multidimensional scaling, and topologically continuous maps.

The method of determining the identity of a drug or drug formulation by recognizing a pattern of spectrographic information may also include the step of interpolating to get an estimate of the concentration of the drug or drug corresponding to the matching identification dataset when the initial dataset matches the identification dataset within the threshold range. Reporting that the initial dataset does or does not match an identification dataset may comprise reporting the concentration of the drug or drugs correspond to the identification dataset when the initial dataset does match the identification dataset within the threshold range.

The step of using the processor to apply one or more pattern recognition techniques may comprise reducing the initial dataset down to four dimensions.

Also described herein are methods of determining the identity of a drug or drug formulation by recognizing a pattern of spectrographic information from a library of known spectrographic information, the methods comprising: receiving an initial dataset comprising multi-dimensional, spectrographic information for an unknown liquid sample, the spectrographic information taken from a plurality of different frequencies; reducing the dimensions of the initial dataset using a linear or non-linear technique to form a reduced dataset; determining how closely the reduced dataset matches an identification dataset of an identification space database, wherein the identification space database comprises a plurality of identification datasets corresponding to known drug compositions; and reporting that the known drug composition corresponding to the identification space database having the closest match to the reduced dataset if the closeness of the match is within a threshold range, or report that the unknown liquid sample does not match a known drug composition of those drugs included in the identification space database if the closeness of match is outside of the threshold range.

The step of reducing the dimensions of the initial dataset may comprise applying a linear technique selected from the group consisting of: principal component analysis, factor analysis, projection pursuit, independent component analysis, multi-objective functions, one-unit objective functions, adaptive methods, batch-mode algorithms, and random projections methods. In some variations the step of reducing the dimensions of the initial dataset comprises applying a non-linear technique selected from the group consisting of: non-linear principle component analysis, non-linear independent component analysis, principle curves, multidimensional scaling, and topologically continuous maps. Reducing the dimensions of the initial dataset may comprise reducing the initial dataset down to four dimensions.

Also described are methods of determining the identity and concentration of a drug by recognizing a pattern of spectrographic information from a library of known spectrographic information, the methods comprising: receiving an initial dataset comprising multi-dimensional, spectrographic information for an unknown liquid sample, the spectrographic information taken from a plurality of different electrode pairs at a plurality of different frequencies; reducing the dimensions of the initial dataset using a linear or non-linear technique to form a reduced dataset; matching the reduced dataset to an identification space database, the identification space database comprising a plurality of identification datasets corresponding to known drug compositions; determining the closeness of the match for the reduced dataset relative to each of the identification datasets; determining a proposed drug composition by applying a threshold to the closeness of the match for each of the identification datasets, wherein the proposed drug composition is unknown if the closeness of match is outside of the threshold range; and determining a concentration of drug in the unknown liquid sample by applying a regression of the proposed drug composition for the known drug composition.

Also described herein are systems collecting and identifying drug waste in a liquid, the system comprising: a waste input port to receive liquid drug waste; a sample chamber coupled to the waste input port, wherein the sample chamber comprises an optically permeable region configured for spectroscopic measurement; a flow sensor configured to determine the flow of liquid into the system; a spectroscopic source and spectroscopic detector configured to provide optical energy to liquid drug waste within the sample chamber at a plurality of frequencies and to detect optical spectroscopic information from the liquid drug waste; a processor configured to receive optical spectroscopic information at a plurality of frequencies from the sample chamber, and to determine the identity and amount of drug in the liquid drug waste from the spectroscopic information and the flow sensor; and a collection chamber to collect liquid drug waste.

Also described herein are systems for collecting and identifying drug waste in a liquid, the system comprising: a waste input port to receive liquid drug waste; a sample chamber coupled to the waste input port, wherein the sample chamber comprises a an optically permeable region configured for spectroscopic measurement; a spectroscopic source and spectroscopic detector configured to measure spectroscopic signatures of liquid drug waste within the sample chamber at a plurality of frequencies; a processor configured to receive spectroscopic information at a plurality of frequencies, and to determine the identity and amount of drug in the liquid drug waste; and a collection chamber to collect liquid drug waste.

In some variations, the spectroscopic source and spectroscopic detector are configured to measure Raman signatures.

In some variations, the spectroscopic source and spectroscopic detector are configured to measure IR signatures.

In some variations, the spectroscopic source and spectroscopic detector are configured to measure UV signatures.

In some variations, the system also includes a plurality of collection chambers.

In some variations, the system also includes a plurality of electrode pairs configured for immittance spectroscopy.

In some variations, the sample chamber is a flow-through chamber configured to pass liquid drug waste therethrough, and further wherein the sample chamber is part of a replaceable cartridge.

In some variations, the system also includes a flow sensor to determine the flow rate of liquid drug waste entering the input port.

In some variations, the processor is configured to log and/or report the identity and amount of drug in a received liquid drug waste.

In some variations, the system also includes an output to report the identity and amount of drug received.

In some variations, the processor is configured to direct the collection of liquid drug waste to one of a plurality of collection chambers based on the identity of the drug in a received liquid drug waste.

In some variations, the system also includes a rinse module connected to a source of rinsate to rinse the sample chamber after delivery of a liquid drug waste.

In some variations, the processor is configured to determine the identity and amount of drug in the liquid drug waste received by comparing the spectroscopic signature to a library of spectroscopic signatures of known drugs.

### BRIEF DESCRIPTION OF THE DRAWINGS

FIG. 1 is a schematic of one variation of a spectrographic system for determining the composition of a liquid.

FIG. 2 shows one variation of an IV waste system.

FIGS. 3A and 3B show front and back perspective views, respectively, of another variation of an IV waste system.

### DETAILED DESCRIPTION

Described herein are devices, systems, and methods for determining the composition of liquids. The composition to be determined may include the identity of one or more compounds in the fluid solution (diluent), and thus may refer to the identity and in some contexts both identity and concentration of one or more of these compounds. In some variations, all of the components of a liquid may be determined, including the identity of the liquid (e.g., saline, etc.). The systems, methods and devices described herein are spectrographic systems (which may be optical, immittance, including admittance or impedance spectrographic systems, or the like), methods and devices which determine the spectrographic signature of a solution at multiple applied frequencies in order to determine characteristic properties that may be used to determine the composition.

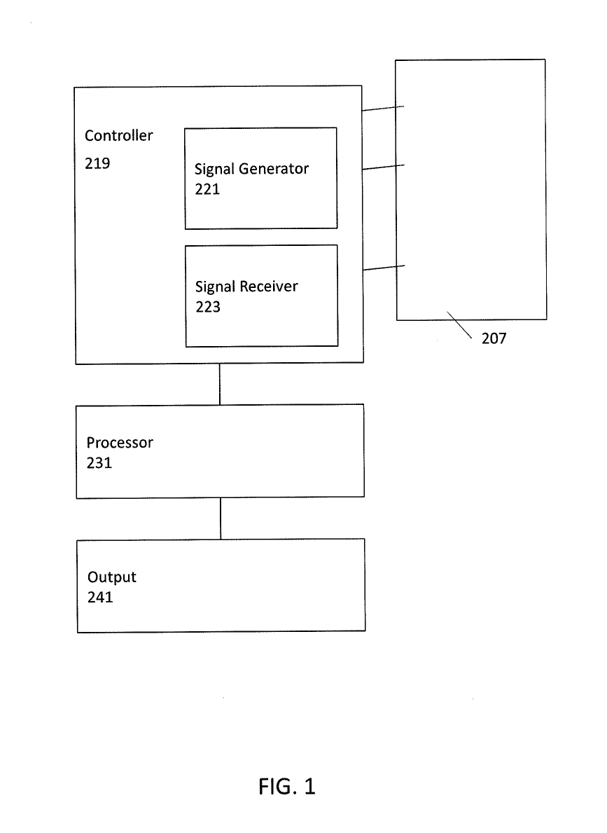

In particular, described herein are spectrographic systems for determining the composition (identity and/or concentration) of materials in a drug waste system. For example, FIG. 1 shows one variation of a generic description of a system (which may be configured as a device) for determining the composition of an aqueous solution. This generic system may be modified in a variety of unique ways as described in greater detail below in order to improve its functioning and adapt the device for specific applications.

For example, a system or device may include a sensor 207. Typically, the sensor 207 includes a chamber for holding the solution to be tested. The chamber may be adapted to take a spectrographic measurement. For example, the chamber may be transparent (optically transparent) to energy applied to the material, and also include an optical path to allow reading of a signal from the material after applying the energy.

A system or device may also include a signal generator 221 for applying energy to the liquid being examined, and particularly across the sensor to a detector or receiver 223. The system generator may operate over a range of frequencies and sensor amplitudes. The generator may apply frequencies and amplitudes larger or smaller than these ranges.

The system may also include a signal receiver 231 for receiving a signal representing the spectrographic signal (e.g., optical signal). The sensor and/or the signal receiver may include processing (amplification, filtering, or the like). In some variations the system includes a controller 219 for coordinating the application of the signal, and for receiving the spectrographic data. For example, a controller may include a trigger, clock or other timing mechanisms for coordinating the application of energy and receiving a signal. The system or device, including controller 219, may also include a memory for recording/aggregating/storing the spectrographic signal information, and/or communications elements (not shown) for passing the data on, including wired or wireless communication means. The controller may generate datasets corresponding to the data at different frequencies.

As mentioned, a controller may include software, firmware, and/or hardware for control, data acquisition, data display and data storage. For example, one variation of a system utilizes a National Instruments Model 9632 SBRIO board in conjunction with LabView software that controls the system, acquires and displays data and stores that data in a spreadsheet formatted text file.

An additional sensor or sensors (not shown) may also be included, or the sensor 207 may include one or more additional elements for measuring other fluid properties, such as flow, temperature, or the like. A controller may control multiple sensors, including immittance sensors.

A system or device may also include a processor 231 for analyzing the data to determine the composition of the liquid, and/or for controlling other aspects of the system, as described below (e.g., pumps, fluid delivery, fluid collection, etc.). The controller and/or processor may also process any additional data collected from the sensor 207 or additional sensors, such as temperature, flow, etc.

In some variations the processor 231 determines the composition of the aqueous solution based on the spectrographic information. The processor may be integrated with the system, or it may be separate (e.g., remote) or shared with other controllers and/or sensors. Details and examples of the processor are described in greater detail below. A processor 231 may include logic (executable as hardware, software, firmware, or the like) that processes and/or analyzes the initial dataset to determine the composition and/or concentration of the one or more compounds in the liquid (solution). The processor may also determine the total amount of composition (in a solution or delivered). Thus, a processor may receive information from one or more sensors that may also be used to help characterize the administration of the liquid, or the operation of other devices associated with the liquid.

Finally, a device or system may include an output 241 for reporting, recording and/or acting on the identified composition of the aqueous solution. A reporting output may be visual, audible, printed, digital, or any other appropriate signal. In some variations described herein, the system or device may regulate or modify activity of one or more devices associated with the liquid or with a patient receiving liquid. For example, a system may turn off or limit delivery of a substance by controlling operation of a pump or valve based on the analysis of the composition of the fluid.

In some variations, the systems for determining the composition of a liquid solution described herein may be configured to keep track of medical (e.g., IV drug) waste. Hospitals and other institutions are increasingly required to document proper disposal of environmentally sensitive waste and monitor for diversion of scheduled drugs. The IV Waste/diversion detection systems described herein, which may be referred to as “IV waste systems” for convenience, the IV waste systems may be designed to enable and automate compliance with both objectives.

In some variations, the IV waste system consists of a channel containing a sensor connected to a processor which rapidly determines drug identity and concentration. These systems or devices may also contain a flow meter to determine total volume of fluid and one or more waste containers into which the fluid can be sorted and deposited after being recognized to insure waste is in the proper containers for disposal. It can be used to identify scheduled drugs in IV bag or syringe returns, including total dose remaining, and can be used to record and segregate environmentally sensitive IV waste documenting the correct disposal into reservoirs for incineration or chemical decomposition. The device may operate empirically, independently certifying IV fluid waste for drug diversion detection and/or environmental waste disposal.

In one embodiment, the IV waste system may be operated by first attaching a bag or syringe to waste input port of device. Fluid may then be forced through a waste input port. The system/device may identify and record the identity, concentration and volume of the fluid and calculate total amount of drug discarded based on the composition. It may also divert the dose into the appropriate reservoir for disposal, segregating different classes of waste appropriately. Thereafter the empty bag or syringe may be discarded in appropriate waste.

Pharmaceuticals are considered organic wastewater contaminants by the US Geological Survey and pharmaceutical wastes are considered to be hazardous waste under EPA's Resource Conservation and Recovery Act (RCRA). Hospital pharmacists, safety, environmental services, and facility managers have difficulty applying RCRA to the complex pharmaceutical waste stream. The EPA and state environmental agencies can levy corporate fines up to $37,500 per violation per day (a violation can be defined as one item discarded into the wrong waste stream). Personal liability can be assessed from the department manager up through the chain of command to the CEO, and can include fines and prison terms.

Pharmaceutical waste is not one single waste stream, but several distinct waste streams that reflect the complexity and diversity of the chemicals that comprise pharmaceutical dosage forms. Healthcare has not typically focused on waste stream management, so there is little experience with the proper methods for segregating and disposing of pharmaceutical waste. Compounding this problem, medicinal drugs are often diverted from their intended therapeutic use for illicit use, i.e. drug abuse, by those doing the diversion or by others for whom the procurement is made. Substance abuse among nurses can range from 2% to 18% (Sullivan & Decker, 2001). The rate for prescription type drug misuse is 6.9% (Trinkoff, Storr, & Wall, 1991). The prevalence of chemical dependency is 6% to 8% (130 to 170,000) according to the ANA estimates (Smith et al., 1998). The Indiana Board of Nursing estimates that 15% nurses abuse drugs found in hospitals. The American Society of Anesthesiologists reports that 12 anesthesiologists die from overdoses of fentanyl a year and as a whole, Anesthesiologists abuse drugs at a rate three times that of the general physician population.

Among the most commonly diverted drugs are those frequently or primarily administered by IV in hospitals including fentanyl, for which there is no current technology for detecting diversion, and morphine and hydromorphone. Many oral drugs are also diverted and many hospitals use dispensing machines and diversion detection software to identify and mitigate the problem of diverting oral medications.

IV waste systems may be configured as compact devices that provide rapid and convenient identification and empirical records of any unused portions of scheduled and/or environmentally sensitive drugs that must be disposed of when not completely delivered to patients. Disposal may consist of segregation and sequestration into disposable waste containers for incineration, chemical decomposition, or other remediation approaches. Waste containers are easily accessible for quick removal and replacement with new containers, and are expected to be disposable with the waste they contain, usually by incineration.

In some variations, the sensor including, if needed, any flow sensor, may be contained in a disposable cassette that would be replaced after a number of uses. The cassette would be exchanged with a new cassette and the replacement would connect the new cassette with the IV waste fluid path downstream of the port and upstream of the waste containers. The cassette may contain the port and/or fluid path so that a fresh port and/or fluid path may also be included in each sensor cassette change. The sensor cassette may also make contact with the processor to operate the sensor and interpret signals to create drug fingerprints and identify such fingerprints in the drug database.

An IV waste system or device may contain any or all of the following elements: a processor unit as described above, a mechanism for pumping a fluid through a tube (e.g., pump), fluid sensing electronics (including a sensor as described herein) and a drug database (library) with IV drug/dose/diluent fingerprints and a waste disposal compliance library, a monitor (for displaying drug, dose, diluent, and waste disposal compliance or diversion detection logging), a touch screen and/or buttons for interacting with the device, one or more waste reservoir tanks for waste disposal, a rinsate reservoir and pump or gravity feed, a power cord and a backup rechargeable battery power supply in case power is interrupted, and a connection to a hospital IT network. The battery power supply and small size insure the IV waste system or device is portable for use anywhere inside or outside a healthcare institution.

In some variations, IV fluid can be introduced into an IV waste system waste input port via user pressure, i.e. pushing a syringe connected to the waste input port, or pushing on a bag to drive out residual fluid. Such a device may include sensing flow through the IV waste channel as well as identity and concentration so that total drug dose wasted or tested for diversion can be calculated and documented. After each measurement, user may need to rinse the IV waste input port and detection channel to insure proper measurement of subsequent samples.

In some variations, IV fluid (waste) is introduced into the IV waste waste input port via a pump, i.e. any syringe or bag connected to the waste input port will have the residual fluid emptied automatically at a constant rate. Such a device may not need to include sensing flow through the IV waste channel since total drug dose wasted or tested for diversion can be calculated and documented using concentration and the rate of pump operation (volume of fluid per unit of time). After each measurement, user may need to rinse the IV waste input port and detection channel to insure proper measurement of subsequent samples.

Any of the systems, including the IV waste systems, described herein may also include automated rinsing of the sensor(s) and other components between sensing/testing. For example, IV fluid that remains in the IV waste input port or sensing channel after the complete wasting or diversion measurement has been made may interfere with subsequent fluids. Therefore a manual or automatic rinse of the input port and channel may be required. An automatic rinse would include a reservoir of rinsate which could include a connection to a distilled water line or an actual reservoir bottle or tank of pure diluent from sterile water to IV fluids such as D5W (5% dextrose in water) or NS (0.9% normal saline). The device may remove an aliquot of rinsate and pump it through the input port and channel using a pump, or the positive pressure of a water line or gravity from a reservoir above the device.

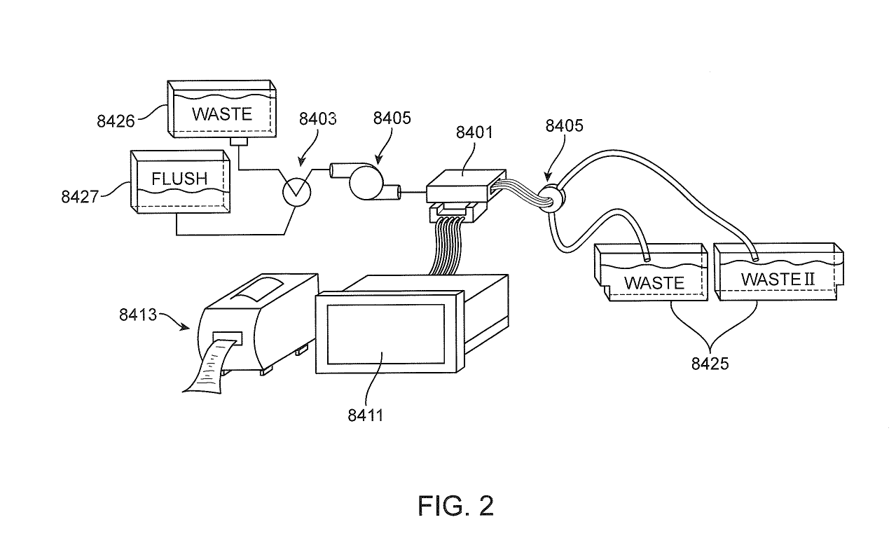

In some variations the system also includes: 2 switching valves, a pump and the overhead for the power distribution and automation controls and plumbing. For example, FIG. 2 shows two waste destinations and one flush solvent source. The design allows for wall, ceiling or floor mounting and the liquid station can go below, on the side, etc. In general, the system can have a printer, scanner etc. for producing a hardcopy of the activity/status of the system. A mentioned above, the system may include a semi-disposable sensor cartridge and interface. The user may install and maintain the cartridge in this “side-module” and there would be a tubing interface for syringes/bags and a cable going to the main unit and placed on the deck so the work is right in front of them. This work module can also have a small status display. The liquid supply and waste containers can be placed on the side of the unit, in back, below or anywhere convenient. The system can connect to the liquid via tubing plumbed from the main unit to custom caps on the containers. There can be a structure that routs these tubes to keep them from being in the way. The containers can be installed in special racks and/or plates that keep them safe and easy and safe to use. The containers, caps trays, plates and racks can all be color coated to help the user identify the correct material. The containers can be round or square. There can be additional liquid handling equipment and sensors used to facility the correct queuing of the measurement such as valves, tubing loops, additional switching valves, etc. There may also be a liquid level system to help the user understand when the containers are full or empty. The design may include automation electronics to control the system including motor control, relays and common automation equipment.

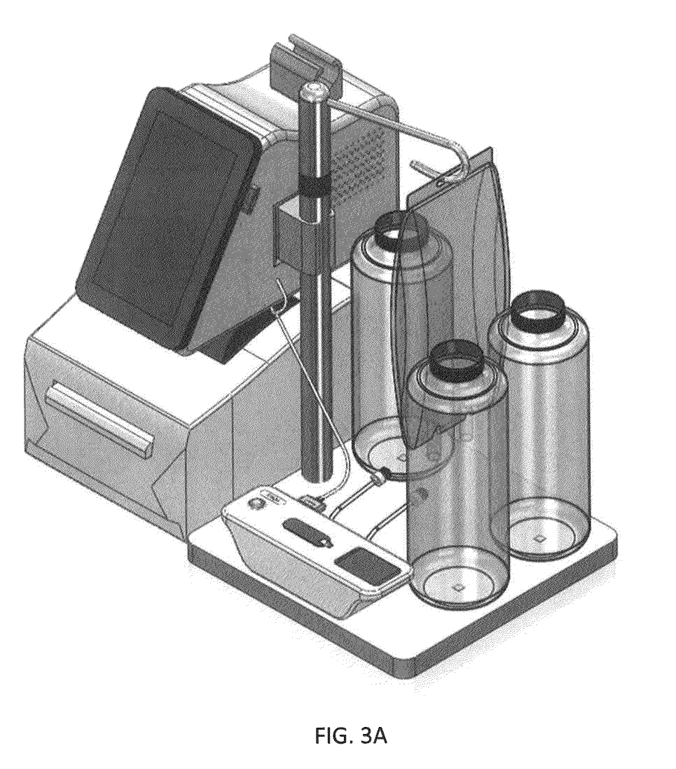

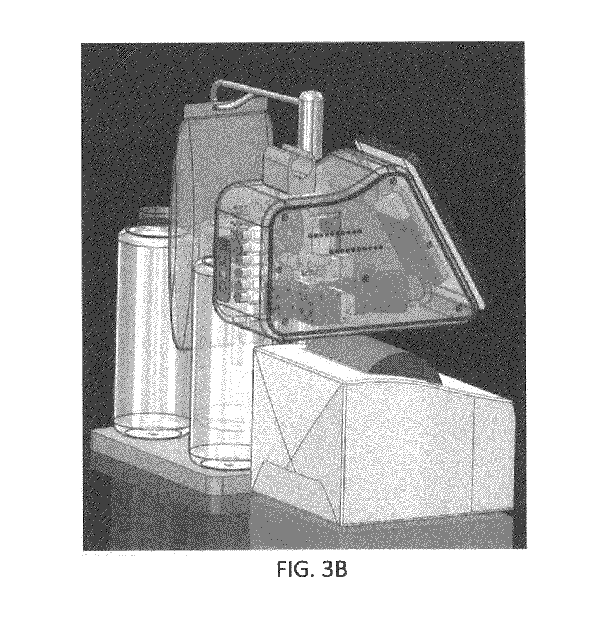

FIG. 2 shows a simplified drawing of one configuration of an IV waste system including a display 8411, printer 8413, processor 8401 (including sensor or sensor cartridge). Two waste containers are included 8425 for storing measured IV waste, and a source container for IV waste is also shown 8426, as is flushing source (e.g., rinsant) 8427. FIGS. 3A and 3B show front and back views, respectively, of another variation of an IV waste system including three waste containers, a source of IV waste (IV bag) and a housing holding the sensor cartridge, printer and electronics (e.g., controller/processor).

The sensing elements of the IV waste working module can be configured as a unit capable of multiple measurements with intermediate cleaning steps. It can consist of the sensor packaging in either of the both above configurations, it can have a calibration electronics installed that are then connected to a bottom flexible circuit that can connect to the exit connector of this module. In some variations the sensing elements are removable. For example, the sensors may be configured as a semi-disposable cartridge so that after an appropriate number of uses the cartridge is removed and replaced.

### System Architecture

In some variations, the systems may have a system architecture that includes a remote server into which client systems (IV check systems, IV delivery systems, IV waste systems, etc.) communicate. Each application may have its own server, or the same server may be used for multiple applications. The server may receive reports from the client systems, and may provide them (securely) to outside databases, including hospital databases. In some variations the servers are configured to be accessed by a web browser platform.

As mentioned, the various systems described herein may be configured in a variety of different ways, and may use different sensors.

May of the systems described herein may include a library of known compositions (including drug identity, dillutent, and concentration). These libraries may be generated a priori or on the fly, specific to a particular setup. For example, a system may allow a user to build a library specific to that system. Thus, the system may be configured to allow a user to make known compositions and use these known compositions to determine library/known “fingerprints” that may later be used to identify a composition of a solution. These fingerprints may be based on the spectrographic characteristics of known solutions measured with the sensor(s) used in in the device.

As mentioned above, in some variations the system may include a flow sensor, either as a separate sensor, or integrated into the system sensor(s).

### Identification of Compounds and Concentrations

All of the systems described herein for using spectroscopy to determine the composition (identity, concentration and diluent) of a liquid typically use some form of pattern recognition. In the simplest form, the system may match a pattern of the spectroscopy information (the “fingerprint”) recorded to a library of known spectroscopic patterns. When these, often complex, and in some cases multi-dimensional, patterns are the same, the composition of the liquid can be affirmatively identified. Since the spectrographic patterns determined as described herein using multiple frequencies are characteristic to the specific components in the liquid, including the identity, concentration and diluent, this pattern recognition provide an accurate and reliable method of determining the composition of the solution.

Pattern recognition, or the process of matching the patterns of a test signal and a known library of signals, has proven difficult and complicated, at least because of the large number of dimensions (often as many as 60) collected, variability in the signals recorded, and slight variations in the concentrations of solutions being tested compared to the known standards in the library. Once solution is to expand the extent and granularity of the library of known signals; the greater the number of known fingerprints, the more likely a match will be identified. Alternatively, it may be possible to use one or more methods that would allow the system to accurately match a test complex fingerprint to a library of complex data within various ranges of accuracy that permits identification and extrapolation from library fingerprints without requiring an exact match. Thus, various pattern recognition techniques are described below that may allow identification of compositions of solutions tested by the system even when the library does not include an exact match. Further, these techniques may allow rapid pattern recognition of even high-dimension datasets of spectrographic data in a rapid (i.e., approaching real-time) manner that would not be possible even when identifying an exact match.

As applied to automated identification of drugs and IV fluids, “pattern recognition” is measuring the raw data from the sensor and either reporting unknown identity or displaying the identity and concentration of drug based on the category or “class” of the pattern. Ideally, the systems would apply a pattern recognition system capable of nearly instantaneously classifying sensor data based on a knowledge extracted from the patterns registered in the prior sets of measurements performed on the known compounds and compositions (the library). Such a system may be referred to as a performing pattern matching system, although patterns in the various applications described herein are not rigidly specified, due in part to inherent variability in composition of the IV fluids, the sensor-to-sensor differences, variability in electronic parameters and other factors including temperature.

The complex data described for the systems herein are typical examples of syntactic (or structural) patterns, where the data is produced by a controlled process as opposed to statistical patterns generated by probabilistic systems. The classification or description scheme therefore is based on the structural interrelationships of features observed in the course of measurements. The data is also an example of multivariate or multidimensional data sets, which dimensions are partially correlated and can be subject to reduction to fewer orthogonal dimensions thus simplifying calculations and reducing storage requirements, defining points in an appropriate multidimensional space.

Although any appropriate pattern recognition technique suitable for comparing (or simplifying and comparing) large dimensional dataset may be used with the systems for identifying the composition of a liquid by spectroscopy described herein, two general types of pattern recognition are described herein: pattern recognition by neural networks and pattern recognition by principle component analysis.

The systems and devices for determining the composition of aqueous solutions described herein may be particularly useful for medical waste applications, though not strictly limited to medical waste applications. The devices, systems and methods described herein may also be useful for measurement or validation of key ingredients in complex fluids for manufacturing. In some variations the systems described herein may also be useful for determining water quality or other testing purposes.

While the methods, devices and systems for determining composition of a solution using spectroscopy have been described in some detail here by way of illustration and example, such illustration and example is for purposes of clarity of understanding only. It will be readily apparent to those of ordinary skill in the art in light of the teachings herein that certain changes and modifications may be made thereto without departing from the spirit and scope of the invention.

What is claimed is:

1. An apparatus for identifying a drug in a liquid, the system comprising:
a sample chamber, wherein the sample chamber comprises a an optically permeable region configured for spectroscopic measurement;
a spectroscopic source and spectroscopic detector configured to measure spectroscopic signatures of liquid drug waste within the sample chamber at a plurality of optical frequencies; and
a processor configured to receive spectroscopic information at a plurality of frequencies, and to determine the identity and amount of drug in the liquid.

2. The system of claim 1, wherein the spectroscopic source and spectroscopic detector are configured to measure Raman signatures.

3. The system of claim 1, wherein the spectroscopic source and spectroscopic detector are configured to measure IR signatures.

4. The system of claim 1, wherein the spectroscopic source and spectroscopic detector are configured to measure UV signatures.

5. The system of claim 1, further comprising a plurality of sample chambers.

6. The system of claim 1, further comprising a plurality of electrode pairs configured for immittance spectroscopy.

7. The system of claim 1, wherein the sample chamber is a flow-through chamber configured to pass liquid drug therethrough, and further wherein the sample chamber is part of a replaceable cartridge.

8. The system of claim 1, further comprising a flow sensor to determine the flow rate of liquid entering sample chamber.

9. The system of claim 1, further comprising an output to report the identity and amount of drug.

10. The system of claim 1, wherein the processor is configured to determine the identity and amount of drug in the liquid by comparing the spectroscopic signature to a library of spectroscopic signatures of known drugs.

11. A system for collecting and identifying drug waste in a liquid, the system comprising:
a waste input port to receive liquid drug waste;
a sample chamber coupled to the waste input port, wherein the sample chamber is configured for spectroscopic measurement of liquid drug waste within the chamber, the sample chamber further comprising a plurality of electrode pairs configured to contact received liquid drug waste;
a spectroscopic light source and spectroscopic detector configured to provide optical energy to liquid drug waste within the sample chamber to detect optical spectroscopic information from the liquid drug waste
a signal generator configured to provide electrical energy to liquid drug waste within the sample chamber at a plurality of frequencies;
a processor configured to receive optical spectroscopic information and complex immittance information for a plurality of frequencies from the plurality of electrode pairs, and to determine the identity and amount of drug in a received liquid drug waste from the optical spectroscopic information and complex immittance information; and
a collection chamber to collect liquid drug waste.

12. A method of collecting and identifying drug waste in a liquid, the method comprising:
receiving a liquid drug waste;
determining spectroscopic information from the liquid drug waste for a plurality of frequencies;
determining the identity and amount of drug in the liquid drug waste by comparing the spectroscopic information to a library of known spectroscopic profiles; and
collecting the liquid drug waste in a collection chamber.

13. The method of claim 12, further comprising recording the amount of drug in the liquid waste received.

14. The method of claim 12, wherein receiving the liquid drug waste comprises pumping the liquid drug waste into a waste input port of a system for collecting and identifying drug waste in a liquid.

15. The method of claim 12, further comprising determining complex immittance information by applying electrical energy at a plurality of frequencies across the plurality of electrode pairs in contact with the liquid drug waste.

16. The method of claim 15, wherein determining the identity and amount of drug comprises using the complex immittance information to determine the identity and amount of drug in the liquid drug waste.

17. The method of claim 12, wherein determining the identity and amount of drug comprises comparing the spectroscopic information with a library of spectroscopic information of known drugs to determine the identity and amount of drug in the liquid drug waste.

18. The method of claim 12, wherein collecting the liquid drug waste comprises collecting liquid drug waste containing different drugs into different collection chambers.
